(19) United States
(12) Patent Application Publication
(10) Pub. No.: US 2012/0128811 A1
(43) Pub. Date: May 24, 2012

(54) DOUBLE-SIDED IMPRINTING DEVICE

(75) Inventors: Noritake SHIZAWA, Kamisato (JP); Kyoichi Mori, Kamisato (JP); Toshimitsu Shiraishi, Kamisato (JP); Naoaki Yamashita, Kamisato (JP)

(73) Assignee: Hitachi High-Technologies Corporation

(21) Appl. No.: 13/293,324

(22) Filed: Nov. 10, 2011

(30) Foreign Application Priority Data
Nov. 19, 2010 (JP) 2010-258714

(51) Int. Cl. B29C 59/02

(52) U.S. Cl. 425/385

(57) ABSTRACT

A double-sided imprinting device includes a top-side stamper device supported by a going up and down mechanism, and a bottom-side stamper device and a transferred body detachment device firmly provided on a moving table placed on a guide rail, in which the moving table can be moved back and forth on the guide rail by a movement driving mechanism, with a position of the top-side stamper device as a center, the bottom-side stamper device and the transferred body detachment device can move alternately to a position opposing the top-side stamper device. A bottom-side stamper provided at the bottom-side stamper device has a rectangular shape and a top-side stamper provided at the top-side stamper device has a rectangular shape so that the rectangular-shaped bottom-side stamper and the rectangular-shaped top-side stamper are provided so as to oppose in a cross shape.

### BACKGROUND OF THE INVENTION

The present invention relates to a double-sided imprinting device suitable for application, such as a discrete track media, forming a fine structure on both surfaces. The invention more specifically relates to a double-sided imprinting device with improved detachability of bottom-side and top-side stampers by changing their shapes and arrangements.

With dramatic functional improvement of various information devices such as a computer, the amount of information handled by the user has continuously increased, achieving from a giga unit region to a tera unit region. Under such an environment, there has been an increasing demand on semiconductor devices such as an information storage and reproduction device and a memory with even higher recording density than ever.

In order to increase the recording density, an even finer processing technique is required. A conventional optical lithography method using an exposure process can perform fine processing on a large area at one time, but has no resolution equal to or smaller than a light wavelength and thus is not suitable for fabricating a fine structure with a wavelength equal to or smaller than the light wavelength (for example, 100 nm or below). Techniques of processing a fine structure with a light wavelength or below include: an exposure technique using an electric line; an exposure technique using an X-ray; an exposure technique using an ion line; etc. However, pattern formation with an electric line drawing device takes time in drawing (exposure) with an increase in the number of patterns to be drawn with the electronic line. Therefore, with an increase in recording density, time required for fine pattern formation becomes longer, resulting in a dramatic decrease in manufacturing throughput. On the other hand, in order to speed up the pattern formation with the electronic line drawing device, a collective graphic irradiation method of combining masks of various shapes and irradiating them in block with an electric line has been in development. However, with an increase in size of the electric line drawing device using the collective graphic irradiation method, a mechanism of controlling a mask position with even higher accuracy is further required, resulting in increased costs of the drawing device itself, which consequently causes problems, for example, an increase in medium manufacturing costs.

Suggested as the technique of processing a fine structure with a light wavelength or below is, in place of a conventional exposure technique, a method by a print technique. For example, described in US005772905A is an invention related to “a nano imprinting lithography (NIL) technique”. The nano imprinting lithography (NIL) technique is a technique of by previously using a technique (for example, electric line exposure technique) of processing a fine structure with a light wavelength or below, pressing a mold formed with a predetermined fine structure pattern against a resist-applied transferred body substrate while applying pressure and then transferring the fine structure pattern of the mold onto a resist layer of the transferred body substrate. As long as the mold is provided, any special high-cost exposure device is not required and replica can be mass-produced with a normal printer level device. Therefore, through put dramatically improves compared to the electric line exposure technology, etc., and also manufacturing costs dramatically decrease. A device used for this purpose is called “fine structure transfer device” or “imprinting device)”.

In the nano imprinting lithography (NIL) technique, in a case where a thermoplastic resin is used as the resist, while a temperature is increased to a temperature near or equal to or larger than a glass transition temperature (Tg) of this material and pressure is applied to perform the transfer. This method is called a thermal transfer method. The thermal transfer method has an advantage such that any of a wide range of general-purpose resins can be used as long as it is a thermoplastic resin. On the contrary, in a case where a photo-sensitive resin is used as the resist, the transfer is performed with photo-curable resin that is cured as a result of exposure to light such as ultraviolet rays. This method is called a optical transfer method.

The nano imprinting processing method of the optical transfer type requires use of special photo-curable resin, but it is advantageous in that a dimensional error between completed products as a result of thermal expansion of a transfer print board or a printed member can be reduced. Moreover, it is also advantageous, for example, in that on the device, equipment for a heating mechanism and accessory devices for temperature increase, temperature control, cooling, etc. are not required and in that further for the entire imprinting (fine structure transfer) device, any design consideration for thermal distortion measures such as heat insulation is not required.

One example of the imprinting (fine structure transfer) device of the optical transfer type is described in Patent Document 2 (Japanese Patent Application Laid-open No. 2008-12844). This device is configured such that a stamper that permits transmission of ultraviolet rays therethrough is pressed against a transferred body substrate to which photo-curable resin has been applied and the ultraviolet rays are irradiated from above. Formed on a surface of the stamper pressed against the transferred body substrate is a fine structure pattern.

As shown in Patent Documents 1 and 2, in a conventional imprinting device, a predetermined fine structure pattern has been mainly formed only on one surface of a transferred body. However, there have been strong demands in recent years for forming a fine structure pattern on both surfaces, as in a discrete track media, for the purpose of further increasing recording density.

In order to meet such demands, the inventors applied a double-sided imprinting device as Japanese Patent Application No 2009-294119. General sectional views of one example of the device are shown in FIGS. 1 to 7 accompanying the specification of Japanese Patent Application No 2009-294119. The double-sided imprinting device invented by the inventors includes: a top-side stamper device 5 supported by a going up and down mechanism 17; a bottom-side stamper device 3 and a transferred body detachment device 7 firmly provided on a moving table 9 placed on a guide rail 11. The moving table 9 can be moved back and forth on the guide rail 11 by a movement driving mechanism 15, whereby with a position of the top-side stamper device 5 as a center, the bottom-side stamper device 3 and the transferred body detachment device 7 can move alternately to a position opposing the top-side stamper device 5. In the double-sided imprinting device invented by the inventors, the bottom-side stamper device 3 and the transferred body detachment device 7 are integrally and firmly provided on the moving table 9 placed on the guide rail 11 and thus can make back and forth movement with the position of the top-side stamper device 5 as a center. As a result, for example, to load on the bottom-side stamper device 3 a disc to which a non-cured resist has been applied, the bottom-side stamper device 3 is displaced from the position opposing the top-side stamper device 5, and the transferred body detachment device 7 is made oppose the top-side stamper device 5. After the disc 43 to which the non-cured resist has been applied is loaded onto the bottom-side stamper 29 of the bottom-side stamper device 3, the bottom-side stamper device 3 is moved to the position opposing the top-side stamper device 5, the top-side stamper device 5 is moved down to carry out double-sided transfer operation, and then the top-side stamper device is moved up to detach a transfer-finished disc 53 from the bottom-side stamper device 3. Then the transferred body detachment device 7 is made oppose the top-side stamper device 5, and the transfer-finished disc 53 is detached from the top-side stamper device 5. At this point, the next applied disc can be loaded on the bottom-side stamper device 3. Finally, the transferred body detachment device is displaced from the position opposing the top-side stamper device whereby the transfer-finished disc 53 held at the transferred body detachment device can be collected. As described above, since the next applied disc 43 has already been loaded on the bottom-side stamper device 3, moving the top-side stamper device 5 down towards the bottom-side stamper device 3 permits carrying out the double-sided transfer operation promptly and continuously. As described above, with the double-sided imprinting device of the invention, double-sided imprinting on a transferred body can be performed continuously and efficiently with a set of press mechanisms, which achieves simplification of a device structure, permitting a dramatic throughput increase.

As described above, in the double-sided imprinting device in Japanese Patent Application No. 2009-294119, after the disc 43 to which the non-cured resist has been applied is loaded onto the bottom-side stamper 29 of the bottom-side stamper device 3, the bottom-side stamper device 3 is moved to the position opposing the top-side stamper device 5, the top-side stamper device 5 is moved down, and the top-side stamper 35 and the bottom-side stamper 29 are pressed against the disc 43 to which the non-cured resist has been applied to thereby carry out the double-sided transfer operation, then the top-side stamper device 5 is moved up to detach the transfer-finished disc 53 from the bottom-side stamper 29 of the bottom-side stamper device 3, then the transferred body detachment device 7 is made oppose the top-side stamper device 5, and the transfer-finished disc 53 is detached from the top-side stamper 35 of the top-side stamper device 5.

In the double-sided imprinting device described in Japanese Patent Application No. 2009-294119, the disc held by the top-side and bottom-side stampers while firmly attached to both the top-side and bottom-side stampers can selectively be detached from one of the stampers (for example, the bottom-side stamper) by reducing force of the firm attachment as a result of curving this stamper, and the disc can be held while firmly attached to a surface of the other stamper (for example, the top-side stamper). As shown in FIG. 4 of Japanese Patent Application No. 2009-294119, while the bottom-side stamper 29 is constricted with a clamp 31a of the bottom-side stamper device 3, constricting with a clamp 31b is released to move up the top-side stamper device 5. Then the transfer-finished disc 53 and the bottom-side stamper 29 are gradually detached from a clamp 31a side on which the constricting is achieved. In Japanese Patent Application No. 2009-294119, this detachment method is called a “one end detachment method”.

FIG. 11 is a general perspective view of one example of a conventional stamper 100 used in the double-sided imprinting device in Japanese Patent Application No. 2009-294119. The conventional stamper 100 has an outer shape formed into a substantially true circle as shown in FIG. 11 and a fine pattern surface 102 is provided outwardly in a radius direction from a central part. However, in a case of a circular-shaped stamper, upon detachment of the stamper from one end in accordance with the one end detachment method, a stamper width on a detachment line changes during the course of the detachment whereby curvature changes, which makes it difficult to perform stable detachment. In FIG. 11, an axial line passing through near a center of the circular-shaped stamper serves as a curving-difficult axis, and an axial line in parallel to the aforementioned axial line and passing through near an outer circumference of the circular-shaped stamper serves as a curving-easy axis. Therefore, the detachment becomes more difficult at an area of the circular-shaped stamper closer to a center from the outer circumference. Moreover, the stampers oppose each other with a disc in between as a result of double-sided transfer, but there is no space for end part holding for the purpose of adding a moment in which the stamper is curved, thus hindering smooth detachment operation.

### SUMMARY OF THE INVENTION

Therefore, it is an object of the present invention to provide a double-sided imprinting device having stampers of new shapes and its new arrangements.

The problem described above can be resolved by a double-sided imprinting device including: a top-side stamper device supported by a going up and down mechanism; and a bottom-side stamper device and a transferred body detachment device firmly provided on a moving table placed on a guide rail, in which the moving table can be moved back and forth on the guide rail by a movement driving mechanism, whereby with a position of the top-side stamper device as a center, the bottom-side stamper device and the transferred body detachment device can move alternately to a position opposing the top-side stamper device, wherein a bottom-side stamper provided at the bottom-side stamper device has a rectangular shape and a top-side stamper provided at the top-side stamper device has a rectangular shape, and when the bottom-side stamper device is arranged at the position opposing the top-side stamper device, the rectangular-shaped bottom-side stamper and the rectangular-shaped top-side stamper are respectively provided at the bottom-side stamper device and the top-side stamper device in a manner such that the bottom-side stamper and the top-side stamper oppose each other in a cross shape.

With the double-sided imprinting device of the invention, the bottom-side stamper and the top-side stamper each have a rectangular shape, and thus upon detachment operation, the detachment proceeds towards longitudinal directions of the stampers. Consequently, even when the detachment has proceeded, curvature of a detachment line for a moment is constantly the same, which permits stable detachment.

Moreover, since the bottom-side stamper and the top-side stamper are arranged in the manner such that the bottom-side stamper and the top-side stamper oppose each other in a cross shape, holding end parts of each stamper does not cause vertical interference. This consequently makes it possible to smoothly perform the detachment operation.

### BRIEF DESCRIPTION OF THE DRAWINGS

FIG. 1 is a schematic perspective view of one example of a stamper used in a double-sided imprinting device according to the present invention;

FIG. 2 is a top view of a bottom-side stamper device used in the double-sided imprinting device according to the invention;

FIG. 3 is a general top view showing a state of arrangement of the bottom-side stamper device and a top-side stamper device used in the double-sided imprinting device according to the invention;

FIG. 4 is a general sectional view of one example of the double-sided imprinting device according to the invention;

FIG. 5 is a general sectional view illustrating one process for performing double-sided imprinting operation using the double-sided imprinting device according to the invention shown in FIG. 4;

FIG. 6 is a general sectional view illustrating one process for performing the double-sided imprinting operation using the double-sided imprinting device according to the invention shown in FIG. 4;

FIG. 7 is a partially general sectional view illustrating a state in which the top-side stamper device is moved up to detach a transfer-finished disc from the bottom-side stamper device;

FIG. 8 is a general sectional view illustrating one process for performing the both-sided imprinting operation using the double-sided imprinting device according to the invention shown in FIG. 4;

FIG. 9 is a partially general sectional view illustrating a state in which the transfer-finished disc is detached from the top-side stamper device by a transferred body detachment device in the double-sided imprinting device according to the invention;

FIG. 10 is a general sectional view illustrating one process for performing the double-sided imprinting operation using the double-sided imprinting device according to the invention shown in FIG. 4; and

FIG. 11 is a schematic perspective view of one example of a conventional stamper used in a double-sided imprinting device in Japanese Patent Application No. 2009-294119.

### DESCRIPTION OF THE PREFERRED EMBODIMENTS

Hereinafter, a preferred embodiment of an optical imprinting method of the present invention will be described with reference to the drawings.

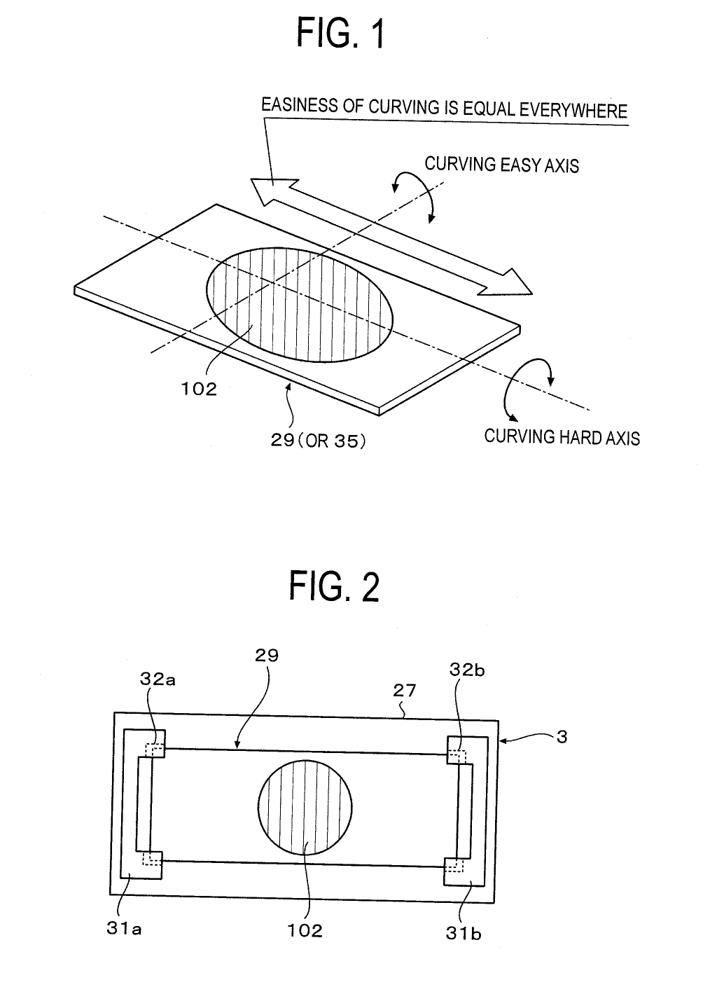

FIG. 1 is a schematic perspective view of one example of a stamper used in a double-sided imprinting device according to the invention. The stamper 29 (or 35) of the invention is rectangular-shaped, with a fine pattern surface 102 provided at a substantially central part. A method of forming the fine pattern is not only known to those skilled in the art but also not a subject of the invention, and thus will be omitted here. The stamper 29 (or 35) is formed of a light-transmissive material (for example, glass, transparent acryl resin, or the like), and has the fine pattern surface 102 formed on one surface. The stamper 29 (or 35) has a rectangular outer shape, and is set at a bottom-side stamper device 3 or a top-side stamper device 5 in a manner such that its detachment is promoted in a longitudinal direction of the stamper 29 (or 35). As a result, even when the detachment is promoted, curvature of a detachment line with respect to a moment always remains the same, which permits stable detachment.

FIG. 2 is a general top view of a state in which the bottom-side stamper 29 shown in FIG. 1 is arranged at a stamper loading table 27 of the bottom-side stamper device 3. The stamper 29 is constricted to a top surface of the stamper loading table 27 of the bottom-side stamper device 3 with stamper clamps 31a and 31b. One of the clamps 31a and 31b is configured to be slightly movable vertically, and one end part of the bottom-side stamper 29 is adapted to be constricting-released from the stamper loading table 27 of the bottom-side stamper device 3. This will be described in detail below, but is a design adopted for the purpose of detaching a disc as a transferred body from the bottom-side stamper 29. Moreover, provided inside the stamper clamps 31a and 31b are guide grooves 32a and 32b for positioning the stamper 29.

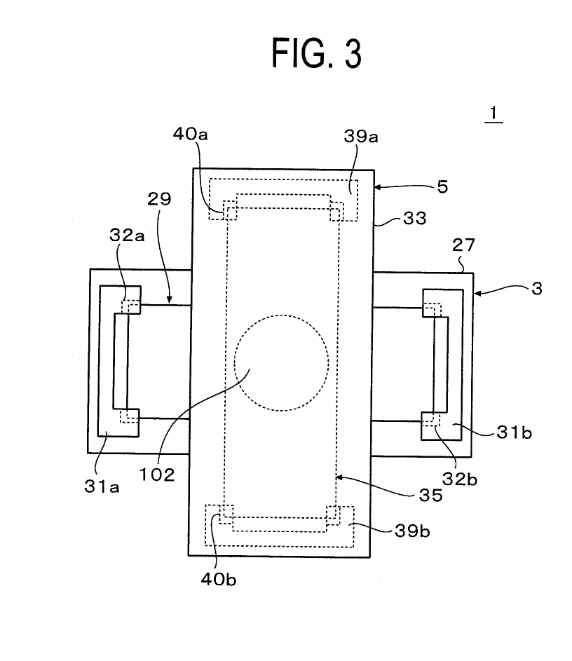

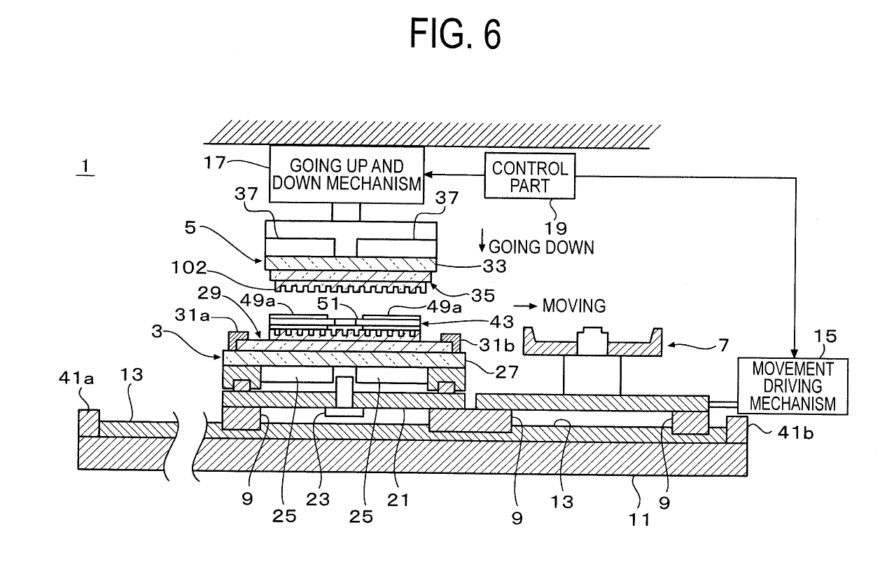

FIG. 3 is a general top view showing a state of arrangement of the bottom-side stamper device and the top-side stamper device. Contrarily to the bottom-side stamper 29, a top-side stamper 35 is constricted to a bottom surface of a stamper support table 33 of the top-side stamper device 5 with stamper clamps 39a and 39b. Also inside the stamper clamps 39a and 39b, guide grooves 40a and 40b for positioning the top-side stamper 35 are respectively provided. As shown in the figure, in the double-sided imprinting device 1 of the invention, at time of imprinting processing, the bottom-side stamper device 3 and the top-side stamper device 5 are arranged in relationship such that their longitudinal directions are orthogonal to each other. The arrangement relationship between the bottom-side stamper device 3 and the top-side stamper device 5 at time of actual imprinting processing is shown in FIG. 6 below. Consequently, the bottom-side stamper 29 opposes the top-side stamper 35 in a cross shape in a manner such that their longitudinal directions are orthogonal to each other with a transferred body sandwiched therebetween. Since the stampers are rectangular-shaped, arranging the bottom-side stamper device 3 and the top-side stamper device 5 in the relationship such that their longitudinal directions are orthogonal to each other results in separation of the clamps 31a and 31b of the bottom-side stamper device 3 and the clamps 39a and 39b of the top-side stamper device 5 from each other at an angle of 90 decrees and avoids vertical interference in end parts holding, which makes it possible to smoothly perform the transferred body separation operation after the imprinting processing.

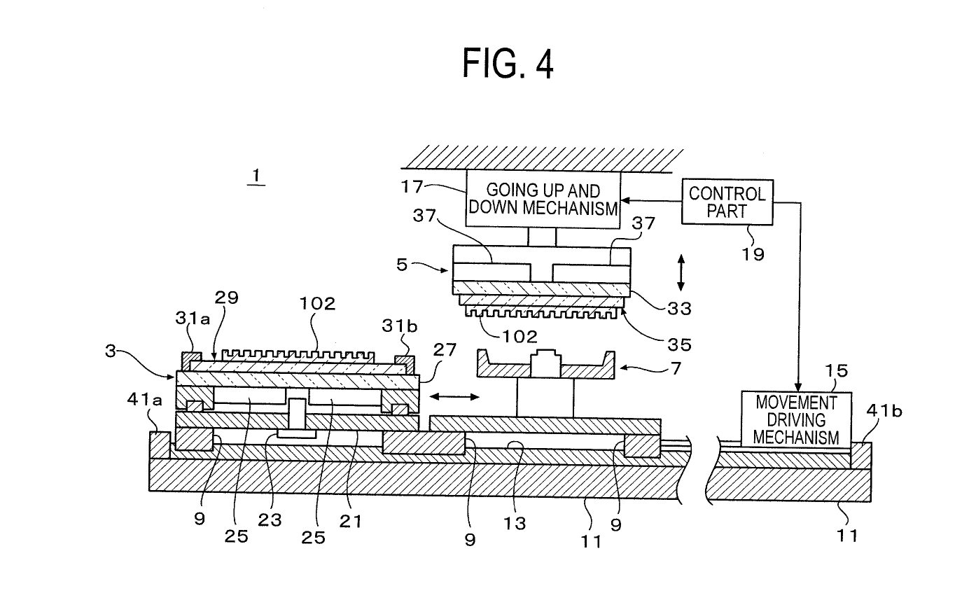

FIG. 4 is a general sectional view of the double-sided imprinting device 1 according to the invention. The device itself shown in FIG. 4 is almost the same as the double-sided imprinting device described in Japanese Patent Application No. 2009-294119. The double-sided imprinting device 1 of FIG. 4 is basically composed of: the bottom-side stamper device 3, the top-side stamper device 5, and a transferred body detachment device 7. The bottom-side stamper device 3 and the transferred body detachment device 7 are firmly provided on a top surface of moving tables 9, which are placed on a guide rail 13 provided on a top surface of a base 11. The moving tables 9 are configured to be integrally movable in a horizontal direction along the guide rail 13 by a well-known movement driving mechanism 15, such as, for example, a stepping motor, a linear motor, or a ball screw. The top-side stamper device 5 is configured to be capable of going up and down by a going up and down mechanism 17. Operation of the movement driving mechanism 15 and the going up and down mechanism 17 is controlled by a control unit 19. Stoppers 41a and 41b may be provided at both end parts of the guide rail 11 when necessary. A difference between the double-sided imprinting device 1 according to the invention shown in FIG. 4 and the double-sided imprinting device described in Japanese Patent Application No. 2009-294119 is that the bottom-side stamper device 3 and the top-side stamper device 5 of the invention are arranged in the relationship as shown in FIG. 3 such that their longitudinal directions are orthogonal to each other.

The bottom-side stamper device 3 is composed of: an XY stage 21, an alignment camera 23, UV light sources 25, the stamper loading table 27, the bottom-side stamper 29, and the stamper clamps 31a and 31b. The stamper loading table 27 and the bottom-side stamper 29 are formed of a light-transmissive material and permits transmission of UV light irradiated from the UV light sources 25. The alignment camera 23 is used for positioning the bottom-side stamper 29 and a disc (not shown) as the transferred body upon loading of the disc onto a top surface of the bottom-side stamper 29. In practice, based on detection information of the alignment camera 23, the XY stage 21 is moved in an X direction and/or a Y direction to position the bottom-side stamper 29 and the disc. The bottom-side stamper 29 is constricted at its circumferential end parts to the stamper loading table 27 with the clamps 31a and 31b. As described in detail below, either of the clamps 31a and 31b is configured to be slightly movable in a vertical direction, which permits release of the constricting of one end part of the bottom-side stamper 29 to the stamper loading table 27. This is a design adopted for the purpose of detaching the disc as the transferred body from the bottom-side stamper 29.

The top-side stamper device 5 is composed of: a stamper support table 33, the top-side stamper 35 arranged on a bottom surface of the stamper support table 33; and UV light sources 37. The stamper support table 33 and the top-side stamper 35 are formed of a light-transmissive material and permits transmission of UV light irradiated from the UV light sources 37. The top-side stamper 35 is constricted to the stamper support table 33 with the clamps 39a and 39b. As described in detail below, either of the clamps 39a and 39b is configured to be slightly movable in a vertical direction, which permits release of the constricting of one end part of the top-side stamper 35 to the stamper support table 33. This is a design adopted for the purpose of detaching the disc as the transferred body from the top-side stamper 35.

As described in detail below, when double-sided imprinting processing has been performed on the disc as the transferred body in the double-sided imprinting device 1, the disc can be detached from the bottom-side stamper 29 of the bottom-side stamper device 3, but remains firmly attached to the top-side stamper 35 of the top-side stamper device 5. Therefore, the transferred body detachment device 7 is used for detaching the disc from the top-side stamper 35 of the top-side stamper device 5.

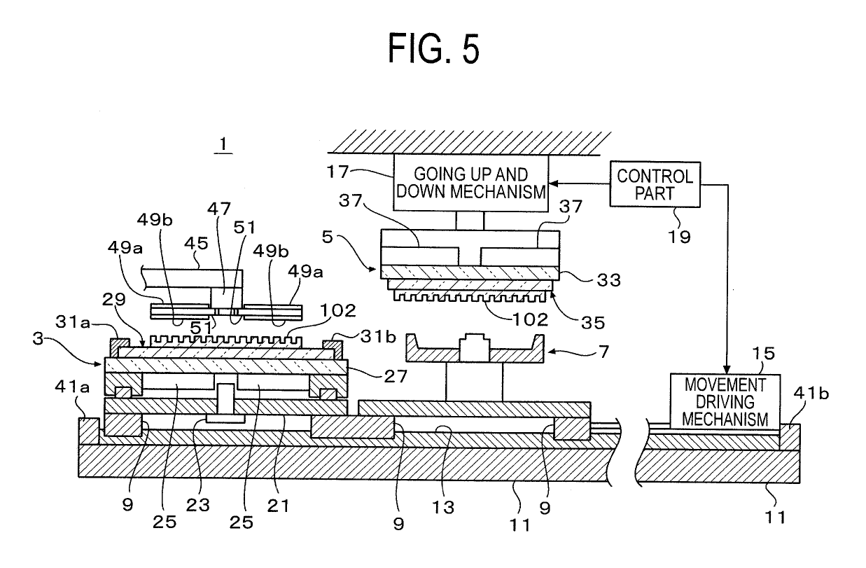

FIG. 5 is a schematic sectional view illustrating a state in which a disc 43 is loaded on the bottom-side stamper 29 of the bottom-side stamper device 3 when the double-sided imprinting processing is performed by using the double-sided imprinting device 1 shown in FIG. 4. The disc 43 having both surfaces to which a photo-curable resist is applied is carried by a disc chuck 47 fitted at a tip of a disc handling arm 45. The resists 49a and 49b are applied all the way to an outer circumferential edge of the disc 43, and therefore the disc 43 cannot be carried in a mode chucking the disc outer circumferential edge. However, at the surroundings of a through hole at a center of the disc 43, a region 51 to which resists 49a and 49b are not applied is provided; therefore, it is preferable to carry the disc 43 by vacuum-suctioning this resist-non-applied region 51 by the disc chuck 47. It is preferable that the disc handling arm 45 be configured to be capable of going up and down and going forward and backward or rotating. Upon the carriage of the disc 43 to a section immediately above the bottom-side stamper 29 by the disc handling arm 45, the alignment camera 23 of the bottom-side stamper device 3 detects alignment marks at a center of an inner diameter center of the disc 43 and a center of the bottom-side stamper 29, and based on a signal of this detection, the XY stage 21 is driven to position the disc 43 and the bottom-side stamper 29. After the positioning of the disc 43 and the bottom-side stamper 29, the disc handling arm 45 is moved down, the disc 43 is loaded on a front surface of the bottom-side stamper 29, and after the vacuum-suction by the disc chuck 47 is released, the disc handling arm 45 is retracted. A method of applying the resists 49a and 49b to the both surfaces of the disc can be achieved by use of a well-known method, such as, for example, spin-coating, spray-coating, roll-coating, or ink jetting. For the spin-coating of the resists to the both surfaces of the disc, a double-side spin coater is commercially available from Nanometric Technology Inc. located in Itabashi, Tokyo. A double-side air spray coater, an electrostatic spray coater, and a roll coater are commercially available from WHY Corporation Ltd. located in Meguro, Tokyo. A device performing inkjet-application of the resists to the both surfaces of the disc is disclosed in the specification of Japanese Patent Application No 2009-161494 filed by the person who filed the application of the invention.

The disc 43 is, for example, a disc substrate like doughnut, such as an HDD, a CD, or a DVD, of a donut shape having a through hole formed at its center. When necessary, regular-use thin films including a metal layer, a resin layer, and an oxide firm layer can be formed on a front surface of the disc 43 to provide a multi-layered structure. For the resists 49a and 49b, for example, a synthetic resin material having addition of a photo-sensitive material can be used. Used as the synthetic resin material can be any of: for example, the one whose main component is cycloolefin polymer, polymethylmethacrylate (PMMA), polystyrene polycarbonate, polyethylene terephthalate (PET), polylactic acid (PLA), polypropylene, polyethylene, and polyvinyl alcohol (PVA). Listed as the photo-sensitive materials are: for example, peroxide, azo compounds (for example, azobisisobutyronitrile), ketone (for example, benzoin or acetone), diazo-aminobenzene, metallic complex salts, or dyes.

FIG. 6 is a general sectional view showing one process of the double-sided imprinting operation performed by the double-sided imprinting device 1 according to the invention shown in FIG. 4. As shown in FIG. 2, when the disc 43 having the resists 49a and 49b applied to both surfaces has been loaded onto the top surface of the bottom-side stamper 29, the bottom-side stamper device 3 and the transferred body detachment device 7, when the moving table 9 has been moved along the guide rail 11 by the movement driving mechanism 15 and the bottom-side stamper device 3 has been moved to a position opposing the top-side stamper device 5, stop at this position. At this point, the bottom-side stamper device 3 and the top-side stamper device 5 are arranged in the relationship as shown in FIG. 3 such that their longitudinal directions are orthogonal to each other. When necessary, with the alignment camera 23 of the bottom-side stamper device 3 detects an alignment mark of the bottom-side stamper 29 and an alignment mark of the top-side stamper 35, and based on a signal of this detection, the XY stage 21 is driven to position the bottom-side stamper 29 and the top-side stamper 35. After the positioning of the bottom-side stamper 29 and the top-side stamper 35, the top-side stamper device 5 is moved down by the going up and down mechanism 17 to press the disc 43 with a predetermined pressure to thereby abut it. Next, UV light is irradiated from the UV light sources 25 of the bottom-side stamper device 3 and the UV light sources 37 of the top-side stamper device 5 to cure the resists 49a and 49b. As a result, the pattern of the bottom-side stamper 29 is transferred onto the bottom-side resist 49b of the disc 43, and the pattern of the top-side stamper 35 is transferred onto the top-side resist 49a As the UV light sources 25 and the UV light sources 37, well-known UV light sources can be used For example, selections can be appropriately made from among a mercury lamp, a high-pressure mercury lamp, a low-pressure mercury lamp, a xenon lamp, and a UV-LED light source. The UV-LED light source in particular is preferable. The UV-LED light source is greatly downsized compared to the mercury lamps, and its ultra-violet wavelength is 365 nm and thus can greatly suppress heat generation, which has no adverse effect or damage on an irradiated object. Further, it is advantageous in that it has low power consumption, is thus environmentally-friendly, and has a long life (10000 to 20000 hours), which can shorten a period in which a line is stopped due to lamp replacement.

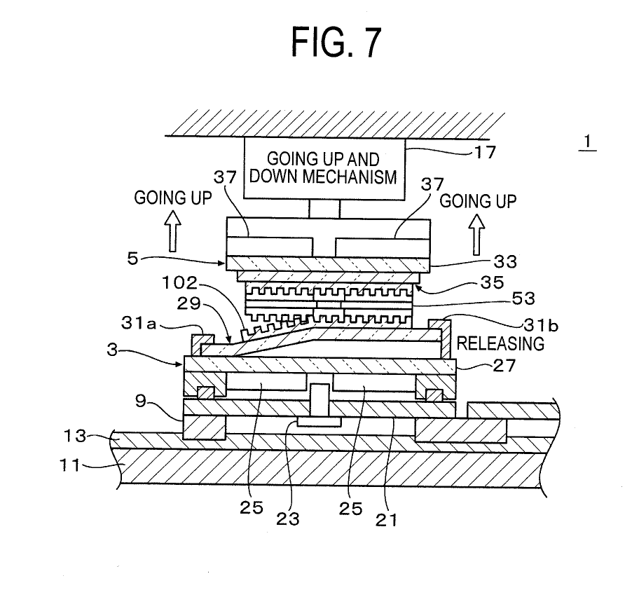

FIG. 7 is a partially general sectional view showing one process of the double-sided imprinting operation performed by the double-sided imprinting device 1 of the invention shown in FIG. 4. As described in FIG. 6, after completion of the pattern transfer onto the both surfaces of the disc 43, a transfer-finished disc 53 is collected next. At this collection, as shown in FIG. 7, while the top-side stamper 35 is constricted with the clamps 39a and 39b of the top-side stamper device 5 and the bottom-side stamper 29 is constricted with the clamp 31a of the bottom-side stamper device 3, the constricting with the clamp 31b is released to move up the top-side stamper device 5. Then the transfer-finished disc 53 and the bottom-side stamper 29 are gradually detached from a clamp 31a side on which the constricting is achieved. Without relying on such a one-end detachment method, moving up the top-side stamper device 5 while the top-side stamper 35 is constricted with the clamps 39a and 39b and the bottom-side stamper 29 is constricted with the clamps 31a and 31b results in failure to detach from the bottom-side stamper 29 the transfer-finished disc 53 due to strong force of mutual firm attachment between each of the stampers 29 and 35 and the transfer-finished disc 53, and forcibly detaching the transfer-finished disc 53 may provide mechanical loss in the top-side stamper 35, the bottom-side stamper 29, and/or the disc In the double-sided imprinting device of the invention, the transfer-finished disc 53 is detached from the bottom-side stamper 29, but unless a state in which the transfer-finished disc 53 remains firmly attached to the top-side stamper 35 is maintained, the processing cannot proceed to the later disc collection process.

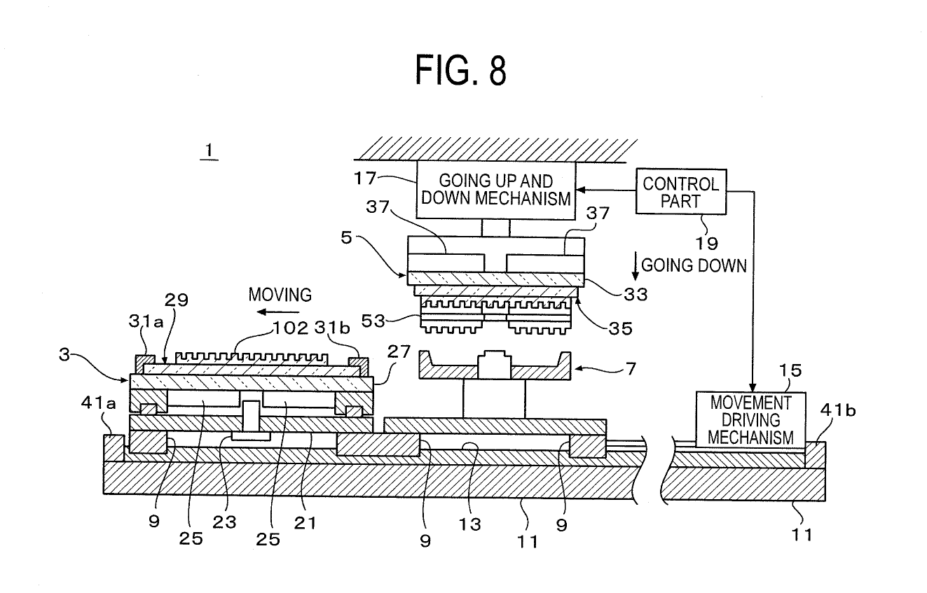

After the detachment of the transfer-finished disc 53 from the bottom-side stamper 29, as shown in FIG. 8, the bottom-side stamper device 3 and the transferred body detachment device 7 firmly provided on the top surface of the moving table 9 are moved along the guide rail 11 by the movement driving mechanism 15. When the transferred body detachment device 7 has been moved to the position opposing the top-side stamper device 5, the transferred body detachment device 7 is stopped at this position. Then the top-side stamper device 5 is moved down by the going up and down mechanism 17 to engage the transfer-finished disc 53 with the transferred body detachment device 7. At this point, as shown in FIG. 5, a next applied disc 43 can be loaded onto the bottom-side stamper device 3.

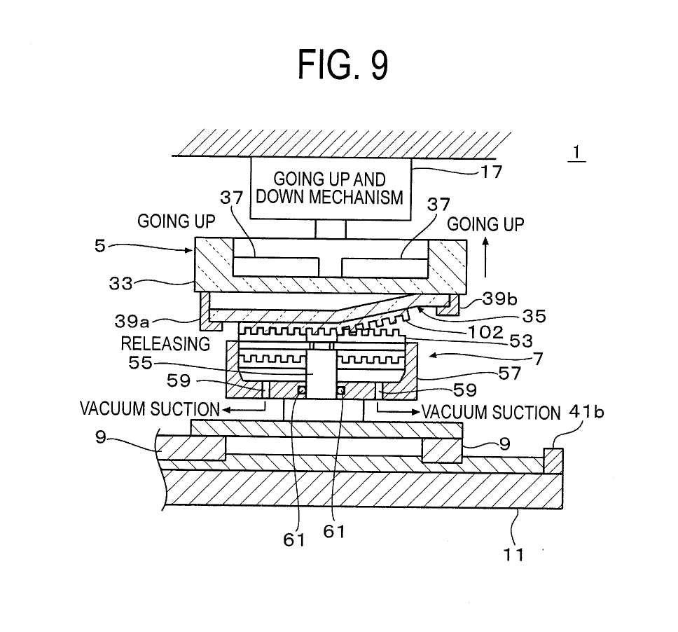

FIG. 9 is a sectional view of the top-side stamper device 5 as viewed from a longitudinal direction. As shown in FIG. 9, a convex part at a top end part of a disc support shaft 55 of the transferred body detachment device 7 is inserted into the through hole at the central part of the transfer-finished disc 53, and the circumferential edge part of the disc 53 is locked to an inner wall surface near a top end of a vacuum-chuck part 57. The inner wall surface of the vacuum-chuck part 57 is preferably configured to widely open towards the top end. At a bottom part of the vacuum-chuck part 57, vacuum-suction ports 59 are provided. Connecting a well-known means such as a vacuum-suction pump to this vacuum-suction ports 59 permits vacuum-chuck of the transfer-finished disc 53. The disc support shaft 55 is configured to be capable of going up and down. This is a mechanism required for passing the transfer-finished disc 53 over to a different unloader. Therefore, it is preferable that an O-ring 61 for maintaining the vacuum-chuck be provided at an sliding interface between the disc support shaft 55 and the vacuum-chuck part 57.

As shown in FIG. 9, in the state in which the transfer-finished disc 53 is engaged with the transferred body detachment device 7 through the vacuum-suction, while one end part of the top-side stamper 35 is constricted with the clamp 39b of the top-side stamper device 5, the clamp 39a is slightly moved down to thereby release the constricting of the other part of the top-side stamper 35 and move up the top-side stamper device 5. Then the top-side stamper 35 is gradually detached from a clamp 39b side on which the constricting is achieved, and finally the transfer-finished disc 53 is completely detached from the top-side stamper 35 and held while vacuum-suctioned to the transferred body detachment device 7.

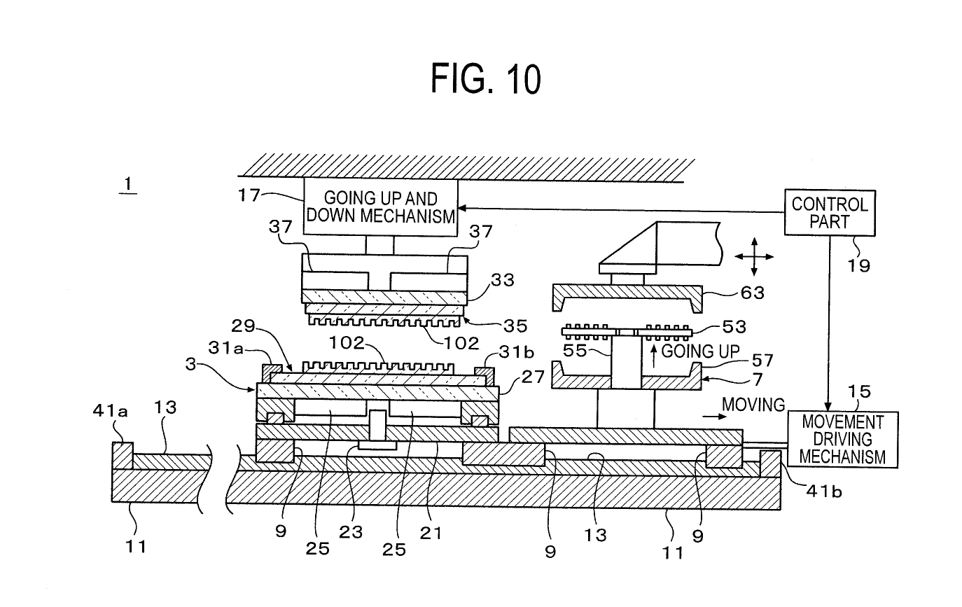

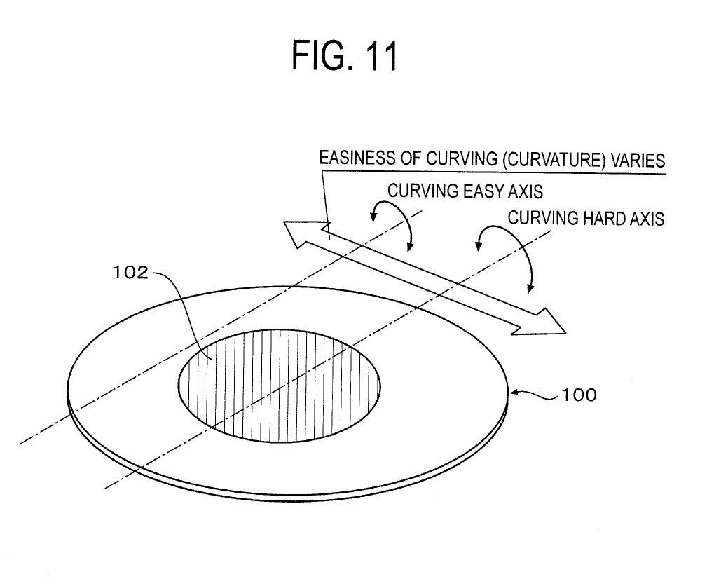

FIG. 10 is a partially general sectional view showing a final process of the both-sided imprinting operation performed by the double-sided imprinting device 1 according to the invention shown in FIG. 4. After the detachment of the disc 53 from the top-side stamper 35, the bottom-side stamper device 3 and the transferred body detachment device 7 firmly provided on the moving table 9 are moved along the guide rail 11, and when the bottom-side stamper device 3 has moved to a position opposing the top-side stamper device 5, the bottom-side stamper device 3 is stopped at this position. The vacuum-chuck by the vacuum-chuck part 57 of the transferred body detachment device 7 is stopped to move up the disc support shaft 55. The transfer-finished disc 53 supported at the top end part of the disc support shaft 55 is collected by an unloader 63 and stored into a product cassette (not shown). It is preferable to use for the unloader 63 a mechanism of a vacuum-chuck type capable of moving in XYZ directions. Such an unloader mechanism is well-known to those skilled in the art. As described above, in a case where the next applied disc 43 has been already been loaded on the bottom-side stamper device 3, simultaneously with operation of unloading the transfer-finished disc 53, the top-side stamper device 5 is moved down and transfer operation is carried out. As a result, with the double-sided imprinting device of the invention, double-sided imprinting can continuously and efficiently be performed on a transferred body, which can dramatically increase throughput.

The preferred embodiment of the double-sided imprinting device of the invention has been described above, but the invention is not limited to the illustrated embodiment and various modifications can be made. For example, in order that air bubbles are not included between the non-cured-regist-applied disc and the stampers, modification of curving a top surface of the stamper loading table or storing the entire double-sided imprinting device into a deaerating chamber can be made.

What is claimed is:

1. A double-sided imprinting device comprising:
a top-side stamper device supported by a going up and down mechanism; and
a bottom-side stamper device and a transferred body detachment device firmly provided on a moving table placed on a guide rail, in which the moving table can be moved back and forth on the guide rail by a movement driving mechanism, whereby with a position of the top-side stamper device as a center, the bottom-side stamper device and the transferred body detachment device can move alternately to a position opposing the top-side stamper device,
wherein a bottom-side stamper provided at the bottom-side stamper device has a rectangular shape and a top-side stamper provided at the top-side stamper device has a rectangular shape,
when the bottom-side stamper device is arranged at the position opposing the top-side stamper device, the rectangular-shaped bottom-side stamper and the rectangular-shaped top-side stamper are respectively provided at the bottom-side stamper device and the top-side stamper device in a manner such that the bottom-side stamper and the top-side stamper oppose to each other in a cross shape.

2. The double-sided imprinting device according to claim 1,
wherein the bottom-side stamper device includes: an XY stage, an alignment camera, a UV light source, a light-transmissive stamper loading table, and the bottom-side stamper constricted to a top surface of the light-transmissive stamper loading table with a bottom-side clamp part,
the top-side stamper device includes: a going up and down mechanism, a light-transmissive stamper support table, the top-side stamper constricted to a bottom side of the support table with a top-side clamp part, and a UV light source, and
the transferred body detachment device includes: a vacuum-chuck part, and a disc support shaft which is positioned at a central part of the vacuum-chuck part and capable of going up and down.

3. The double-sided imprinting device according to claim 2,
Wherein, the bottom-side clamp part includes two or more clamps are provided, and while one of the clamps constricts the stamper, the other clamp can release the constricting of the stamper.

4. The double-sided imprinting device according to claim 2,
Wherein, the top-side clamp part includes two or more clamps are provided, and while one of the clamps constricts the stamper, the other clamp can release the constricting of the stamper.

5. The double-sided imprinting device according to claim 2,
wherein the UV light source is a UV-LED light source.
